(19) United States
(12) Patent Application Publication
(10) Pub. No.: US 2021/0193086 A1
(43) Pub. Date: Jun. 24, 2021

(54) HEAD UP DISPLAY CONFIGURATION

(71) Applicant: Panasonic Automotive Sustems Company of America, Division of Panasonic Corporation of North America, Peachtree City, GA (US)

(72) Inventors: DAVID KAY LAMBERT, STERLING HEIGHTS, MI (US); DAMON EDWARD STAUFFER, CUMMING, GA (US); FIDELIS ITSEDE, ACWORTH, GA (US); PATRICK M. O'CONNELL, NOVI, MI (US)

(21) Appl. No.: 17/116,349

(22) Filed: Dec. 9, 2020

Related U.S. Application Data
(60) Provisional application No. 62/945,919, filed on Dec. 10, 2019.

(51) Int. Cl. G09G 5/38; G06T 3/20; G02B 27/01

(52) U.S. Cl. CPC G09G 5/38; G06T 3/20; G02B 27/0101; G02B 2027/014; G09G 2380/10; G09G 2340/0471; G09G 2354/00; G02B 27/0179

(57) ABSTRACT

A head up display arrangement for a motor vehicle includes a picture generation unit emitting a light field including an image. A mirror is positioned to reflect the light field after the light field has been emitted by the picture generation unit. A windshield is positioned to reflect the light field after the light field has been reflected by the mirror such that a human driver sees the image in the light field after the light field has been reflected by the windshield, and such that the driver sees the image as a virtual image that appears to be outside of the windshield when eyes of the driver are in an imaginary eyebox. An electronic processor is communicatively coupled to the picture generation unit and translates the image on the picture generation unit display to thereby change a vertical level of the eyebox.

### CROSS-REFERENCED TO RELATED APPLICATIONS

This application claims benefit of U.S. Provisional Application No. 62/945,919 filed on Dec. 10, 2019, the disclosure of which is hereby incorporated by reference in its entirety for all purposes.

### BACKGROUND OF THE INVENTION

### 1. Field of the Invention

The present invention relates to a head up display (HUD) of a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

The “instantaneous eyebox” is the area from which the entire virtual image is visible by one eye of an observer. To be precise, for a driver viewing the virtual image projected by an automotive HUD, the instantaneous eyebox is the area in a vertical plane that is perpendicular to the axis of the vehicle from which the entire virtual image projected by the HUD can be seen by one eye.

FIG. 1 illustrates a head up display arrangement of the prior art which enables manual adjustment of the height of the HUD eyebox for the height of the driver. FIG. 1 shows the method currently used to shift the HUD eyebox vertically to accommodate drivers of a range of heights, with an eyebox that has less vertical height than the range in driver heights. A mirror is rotated to move the instantaneous eyebox to be centered on the driver's eye position. Rotation of the mirror is accomplished by a motor and gear system. However, the motor and gear system takes up space within the HUD package and adds complexity. The mirror may be an aspheric mirror that rotates about an axis based on manual driver input. This enables the eyebox height to be adjusted to match the driver's height.

Windshield head-up displays currently adjust the height of the eyebox by rotating a mirror. Rotation of the mirror requires the addition of a kinematics system and its assembly. This kinematics system assembly increases the cost and adds volume to the package.

### SUMMARY OF THE INVENTION

The invention may provide a means to vertically move the instantaneous eyebox in an automotive windshield head-up display (HUD) and enable a driver to optimize the height of the center of the eyebox for the driver's height by changing the area that is active on a fixed display. According to this invention, the instantaneous eyebox is moved by moving the active area on a display, without actual physical motion.

This invention may enable the effect of a mirror rotation to be obtained without actually rotating a mirror. Elimination of a physical motion, in this case a mirror rotation, is obtained by using a display system to translate an image on a display. The display does not move, but the same effect is obtained as if the display has been moved. In particular, the size of the aspherical mirror needed to implement the HUD is approximately unchanged from a HUD with a rotating mirror. The mirror of the invention does not rotate, but the same effect of moving the eyebox is achieved.

The invention comprises, in one form thereof, a head up display arrangement for a motor vehicle. The arrangement includes a picture generation unit emitting a light field including an image. A mirror is positioned to reflect the light field after the light field has been emitted by the picture generation unit. A windshield is positioned to reflect the light field after the light field has been reflected by the mirror such that a human driver sees the image in the light field after the light field has been reflected by the windshield, and such that the driver sees the image as a virtual image that appears to be outside of the windshield when eyes of the driver are in an imaginary eyebox. An electronic processor is communicatively coupled to the picture generation unit and translates the active area on a fixed display, used to display an image that is viewed by the human driver as the virtual image, to thereby change a vertical level of the eyebox.

The invention comprises, in another form thereof, a method of operating a head up display in a motor vehicle, including emitting a light field including an image. The light field is reflected with a mirror after the light field has been emitted. The light field is reflected with a windshield after the light field has been reflected by the mirror such that a human driver sees the image in the light field after the light field has been reflected by the windshield, and such that the driver sees the image as a virtual image that appears to be outside of the windshield when eyes of the driver are in an imaginary eyebox. The active area on a fixed display is translated to thereby change a vertical level of the eyebox.

The invention comprises, in yet another form thereof, a head up display arrangement for a motor vehicle including a display screen emitting an image. A mirror is positioned to reflect the image after the image has been emitted by the display screen. A windshield is positioned to reflect the image after the image has been reflected by the mirror such that a human driver sees the image after the image has been reflected by the windshield, and such that the driver sees the image as a virtual image that appears to be outside of the windshield when eyes of the driver are in an imaginary eyebox. An electronic processor is communicatively coupled to the display screen and changes which portion of the display screen emits the image to thereby change a vertical level of the eyebox. A manual control device is communicatively coupled to the processor and enables the driver to cause a change in which portion of the display screen emits the image.

An advantage of the invention is that, by simply translating the image on a display instead of rotating a mirror, the need for a mirror rotation mechanism is eliminated along with its associated motor, gears, and drive electronics.

Another advantage of the invention is that the noise produced by the mirror rotation mechanism is eliminated.

Yet another advantage of the invention is that it eliminates possible failure modes associated with the motor and the rotation mechanism.

A further advantage of the invention is that it eliminates the need for clearances for mirror motion, and thus reduces the size and mechanical complexity of the HUD package.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic side view of a head up display arrangement of the prior art.

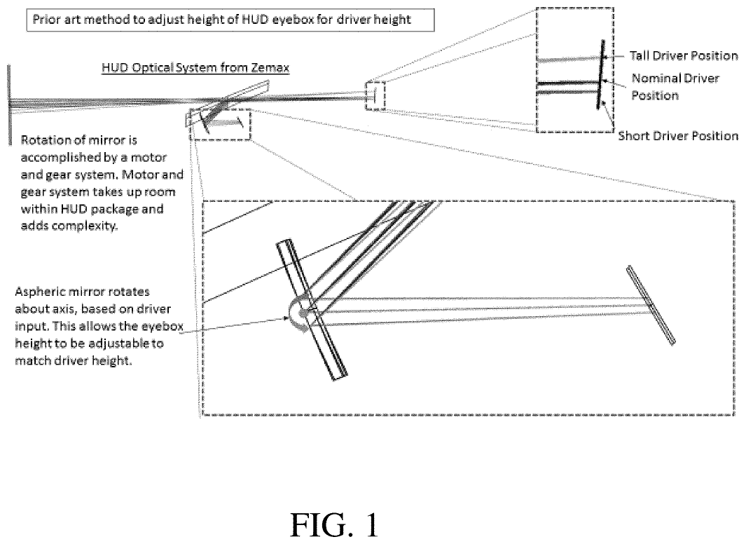

FIG. 2 is a schematic side view of one embodiment of a head up display arrangement of the present invention.

FIG. 3 is a schematic side view of a head up display illustrating the effect of having a larger mirror.

FIG. 4 is a more detailed schematic side view of the head up display arrangement of FIG. 2.

FIG. 5 is a flow chart of one method of the present invention for operating a head up display in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

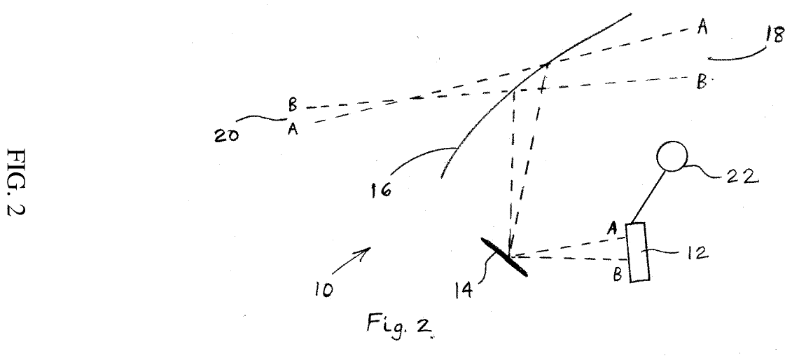

FIG. 2 illustrates one embodiment of a head up display arrangement 10 of the present invention including a picture generation unit in the form of a display screen 12, a mirror 14 and a windshield 16. Display screen 12 may emit a light field including an image within the light field. FIG. 2 also illustrates how the height of an eyebox 18 may be moved vertically between positions A and B by translating the image on display screen 12 between positions A and B. Mirror 14 is stationary and is in the same position regardless of whether the image on display screen 12 is at position A or position B. An image centered at position A on display screen 12 reflects from mirror 14 to create a virtual image 20 that appears to be at position A from eyebox center location A. Similarly, an image centered at position B on display screen 12 reflects from mirror 14 to create a virtual image 20 that appears to be at position B from eyebox center location B.

The driver may be provided with a manual control device 22 to move the image between positions A and B on display screen 12. As the image moves from position A to position B on display screen 12, eyebox 18 moves vertically from position A to position B.

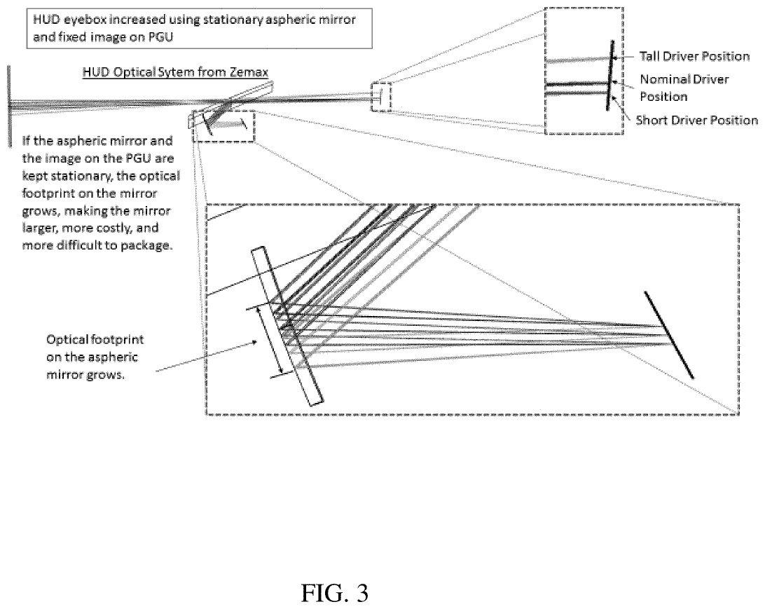

FIG. 3 illustrates the effect of having a larger mirror in a head up display. FIG. 3 illustrates a way of increasing the size of the eyebox to accommodate the full range of driver height with a fixed aspherical mirror and a fixed image on the display. The vertical size of the mirror is increased. That is, FIG. 3 shows the effect of keeping the image on the display screen or picture generation unit (PGU) stationary and increasing the vertical size of the aspherical mirror. The effect is that the size of the eyebox is increased so the instantaneous eyebox covers the entire range of the driver's height. The size of the HUD eyebox is increased using a stationary aspheric mirror and a fixed image on the PGU. If the aspheric mirror and the image on the PGU are kept stationary, the optical footprint on the mirror grows, making the mirror larger, more costly, and more difficult to package.

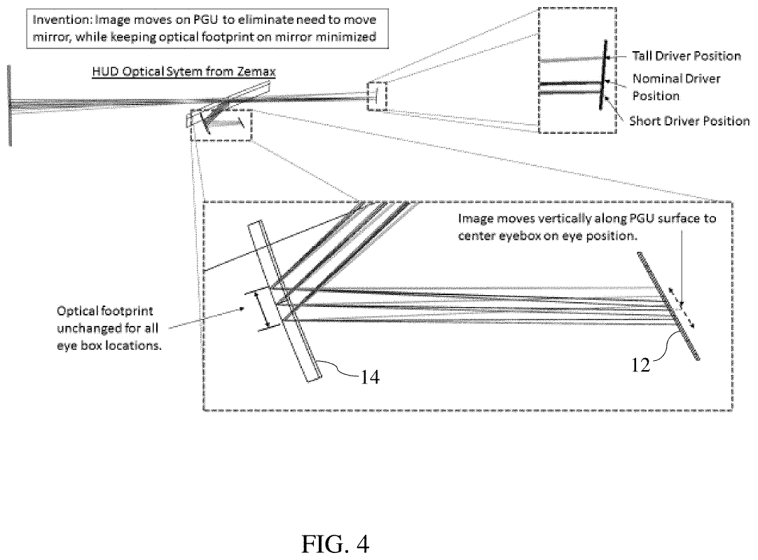

FIG. 4 illustrates head up display arrangement 10 of FIG. 2 in greater detail. The image is moved or translated on PGU 12, but aspherical mirror 14 is kept stationary. The vertical height of aspherical mirror 14 does not increase to cover the entire range of driver height. Instead, the image is moved vertically on the surface or display screen of PGU 12. The image moves on PGU 12 to eliminate the need to move mirror 14, while keeping the optical footprint on mirror 14 minimized. The image moves vertically along the PGU surface to center the eyebox on the eye position. The optical footprint on mirror 14 may be unchanged for all eyebox locations. The eyebox is moved to match the driver's eye location. The vertical size of mirror 14 is the same as for a rotating mirror.

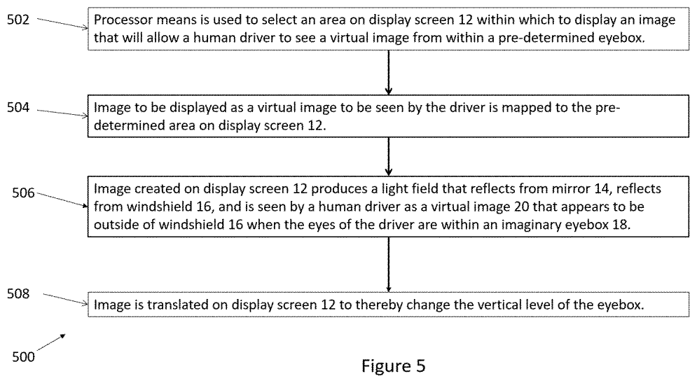

FIG. 5 illustrates one method 500 of the present invention for operating a head up display in a motor vehicle. In a first step 502, a processor means is used to select an area on display screen 12 within which to display an image that will allow a human driver to see a virtual image from within a pre-determined eyebox.

In a next step 504, an image to be displayed as a virtual image is mapped to the pre-determined area on display screen 12.

Next, in step 506, the image created on display screen 12 produces a light field that reflects from mirror 14, reflects from windshield 16, and is seen by a human driver as a virtual image 20 that appears to be outside of windshield 16 when the eyes of the driver are within an imaginary eyebox 18.

In a final step 508, the image is translated on display screen 12 to thereby change a vertical level of the eyebox. For example, manual control device 22 may enable the driver to move the image between positions A and B on display screen 12. As the image moves from position A to position B on display screen 12, eyebox 18 moves vertically from position A to position B.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A head up display arrangement for a motor vehicle, the arrangement comprising:
a picture generation unit configured to emit a light field including an image;
a mirror positioned to reflect the light field after the light field has been emitted by the picture generation unit;
a windshield positioned to reflect the light field after the light field has been reflected by the mirror such that a human driver sees the image in the light field after the light field has been reflected by the windshield, and such that the driver sees the image as a virtual image that appears to be outside of the windshield when eyes of the driver are in an imaginary eyebox; and
an electronic processor communicatively coupled to the picture generation unit and configured to translate the image on the picture generation unit display to thereby change a vertical level of the eyebox.

2. The arrangement of claim 1, wherein the mirror comprises an aspheric mirror.

3. The arrangement of claim 1, wherein the mirror is fixed and nonrotatable.

4. The arrangement of claim 1, further comprising a manual control device communicatively coupled to the processor and configured to enable the driver to cause the image to move on the picture generation unit display.

5. The arrangement of claim 4, wherein the manual control device is configured to enable the driver to cause the image to move on the picture generation unit display until the virtual image is visible to the driver.

6. The arrangement of claim 1, wherein the picture generation unit is fixed and nonrotatable.

7. The arrangement of claim 1, wherein a vertical level of the virtual image is inversely related to a vertical level of the eyebox.

8. A method of operating a head up display in a motor vehicle, the method comprising:
emitting a light field including an image from a picture generation unit display;
reflecting the light field with a mirror after the light field has been emitted;
reflecting the light field with a windshield after the light field has been reflected by the mirror such that a human driver sees the image in the light field after the light field has been reflected by the windshield, and such that the driver sees the image as a virtual image that appears to be outside of the windshield when eyes of the driver are in an imaginary eyebox; and
translating the image on the picture generation unit display to thereby change a vertical level of the eyebox.

9. The method of claim 8 wherein the mirror comprises an aspheric mirror.

10. The method of claim 8, wherein the mirror is fixed and nonrotatable.

11. The method of claim 8, further comprising enabling the driver to cause the image to move on the picture generation unit display.

12. The method of claim 11, wherein the driver is enabled to cause the image to move on the picture generation unit display until the virtual image is visible to the driver.

13. The method of claim 8, wherein a source of the light field is fixed and nonrotatable.

14. The method of claim 8, wherein a vertical level of the virtual image is inversely related to a vertical level of the eyebox.

15. A head up display arrangement for a motor vehicle, the arrangement comprising:
a display screen configured to emit an image;
a mirror positioned to reflect the image after the image has been emitted by the display screen;
a windshield positioned to reflect the image after the image has been reflected by the mirror such that a human driver sees the image after the image has been reflected by the windshield, and such that the driver sees the image as a virtual image that appears to be outside of the windshield when eyes of the driver are in an imaginary eyebox;
an electronic processor communicatively coupled to the display screen and configured to change which portion of the display screen emits the image to thereby change a vertical level of the eyebox; and
a manual control device communicatively coupled to the processor and configured to enable the driver to cause a change in which portion of the display screen emits the image.

16. The arrangement of claim 15, wherein the mirror comprises an aspheric mirror.

17. The arrangement of claim 15, wherein the mirror is fixed and nonrotatable.

18. The arrangement of claim 15, wherein the manual control device is configured to enable the driver to cause the virtual image to be visible to the driver.

19. The arrangement of claim 15, wherein the display screen is fixed and nonrotatable.

20. The arrangement of claim 15, wherein a vertical level of the virtual image is inversely related to a vertical level of the eyebox.
